(19) United States
(12) Patent Application Publication
(10) Pub. No.: US 2023/0302915 A1
(43) Pub. Date: Sep. 28, 2023

(54) BRAKE CONTROL DEVICE

(71) Applicant: Honda Motor Co., Ltd., Tokyo (JP)

(72) Inventor: Shinya KOBAYASHI, Tokyo (JP)

(73) Assignee: Honda Motor Co., Ltd., Tokyo (JP)

(21) Appl. No.: 18/167,868

(22) Filed: Feb. 12, 2023

(30) Foreign Application Priority Data
Mar. 24, 2022 (CN) 202210294905.9

(51) Int. Cl. B60L 7/26; B60L 15/20

(52) U.S. Cl. CPC B60L 7/26; B60L 15/2009; B60T 2270/60

(57) ABSTRACT

The disclosure provides a brake control device for performing brake control of a vehicle. The vehicle has a regenerative braking device and a friction braking device, the regenerative braking device is configured to adjust the regenerative braking force applied to the wheels of the vehicle, and the friction braking device is configured to adjust the frictional braking force applied to the wheels. The brake control device includes a brake control unit to control the regenerative braking device and the friction braking device. When the vehicle is decelerated, after the brake control unit performs a braking force application process to apply frictional braking force to all wheels, the brake control unit increases the regenerative braking force applied to the wheels by converting the frictional braking force applied to the wheels into regenerative braking force.

### CROSS-REFERENCE TO RELATED APPLICATION

This application claims the priority benefit of China application no. 202210294905.9, filed on Mar. 24, 2022. The entirety of the above-mentioned patent application is hereby incorporated by reference herein and made a part of this specification.

### BACKGROUND

### Technical Field

The disclosure relates to a brake control technology for vehicles.

### Description of Related Art

In recent years, in order to secure access to energy that is more affordable, reliable, sustainable and advanced for people, research and development related to improvement of energy efficiency that contributes to energy efficiency has been being carried out.

However, in the technology related to improving energy efficiency, in a vehicle equipped with hydraulic brake and regenerative brake, a vehicle is able to decelerate through the hydraulic brake of all wheels and the regenerative brake of the rear wheels according to the judgment of vehicle speed and attitude. A known control method is that a vehicle is switched to regenerative brake after a predetermined time period to dampen the pitching effect. Also, depending on the charging state of a secondary battery, a braking force of regenerative brake increases when the charge is low and decreases when the amount of charge is large or fully charged, which might cause a pitching effect.

However, when performing brake control to suppress the pitching effect, complex controls such as vehicle speed measurement and attitude confirmation are required, and related costs will be increased.

### SUMMARY

The disclosure is directed to a brake control device, which is able to suppress the pitching effect without measuring the vehicle speed and confirming the attitude of the vehicle, thereby simplifying the brake control process.

The brake control device of the present disclosure is configured for the brake control of vehicles. The vehicle has a regenerative braking device and a friction braking device, the regenerative braking device is configured to adjust the regenerative braking force applied to the wheels of the vehicle, and the friction braking device is configured to adjust the frictional braking force applied to the wheels. The brake control device includes a brake control unit to control the regenerative braking device and the friction braking device. When the vehicle is decelerated, after the brake control unit performs a braking force application process to apply frictional braking force to all wheels, the brake control unit increases the regenerative braking force applied to the wheels by converting the frictional braking force applied to the wheels into regenerative braking force.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain principles of the disclosure.

FIG. 1 is a schematic view of a brake control device according to an embodiment of the present disclosure.

FIG. 2 is a flowchart of a brake control method of a brake control device according to an embodiment of the present disclosure.

FIG. 3 is a schematic view illustrating a situation of a brake control method of a brake control device according to an embodiment of the present disclosure.

FIG. 4 is a schematic view illustrating a situation of a brake control method of a brake control device according to another embodiment of the present disclosure.

### DESCRIPTION OF THE EMBODIMENTS

Reference will now be made in detail to the exemplary embodiments of the present disclosure, examples of which are illustrated in the accompanying drawings. Wherever possible, the same reference numbers will be used in the drawings and description to refer to the same or like parts.

In an embodiment of the present disclosure, the brake control unit is adopted when the accelerator pedal is turned off, and the brake control unit will perform a braking force application process to apply frictional braking force to all wheels.

In an embodiment of the present disclosure, the vehicle has an accelerator pedal opening signal detection device. When the accelerator pedal opening signal detection device detects that the accelerator pedal opening decreases at a predetermined rate, the brake control unit will perform a braking force application process to apply frictional braking force to all wheels.

In an embodiment of the present disclosure, the brake control unit is adopted when performing a braking operation, and the brake control unit will perform a braking force application process to apply frictional braking force to all wheels.

In an embodiment of the present disclosure, the vehicle has a vehicle speed detection device for detecting the vehicle speed, and a brake pedal force detection switch attached to the brake pedal for detecting the brake pedal force is equipped with a brake pad temperature estimating device, the brake pad temperature estimating device estimates the brake pad temperature according to the vehicle speed and the brake pedal force. When the brake pad temperature is greater than a set threshold, the brake control unit will not perform brake control.

In an embodiment according to the disclosure, the vehicle has a cruise control device. When the cruise control is activated, and when the vehicle is decelerating due to the operation of the brake pedal, the brake control unit will not perform brake control.

In an embodiment of the present disclosure, the vehicle has a gear position detection device to detect the gear position of a transmission selected by the driver. When the gear position detection device detects a shift to a gear with increased deceleration, the same frictional braking force as selected during normal gear shifting will be applied to all wheels, and the insufficient portion will be applied by regenerative braking force.

In an embodiment of the present disclosure, the vehicle is driven using an electric motor. In a vehicle performing regenerative braking, an electric motor generates torque to drive a driving side when an accelerator pedal is treaded, and an electric motor generates torque to drive a deceleration side when a brake pedal is treaded. When the vehicle is decelerated due to the off operation of the accelerator pedal, the braking force application in which the brake control unit applies frictional braking force to all the wheels and the regenerative braking force application in which the regenerative braking force is smaller than the frictional braking force will be applied to the electric motor. The brake control unit simultaneously performs the braking force application process and the regenerative braking force application process within a predetermined time. The predetermined time is a time period from the application of the braking force to the stabilization of the attitude of the vehicle. When the attitude of the vehicle is stabilized, the regenerative braking force applied to the electric motor is gradually increased, and the frictional braking force applied to the wheels driven by the electric motor will be converted into regenerative braking force.

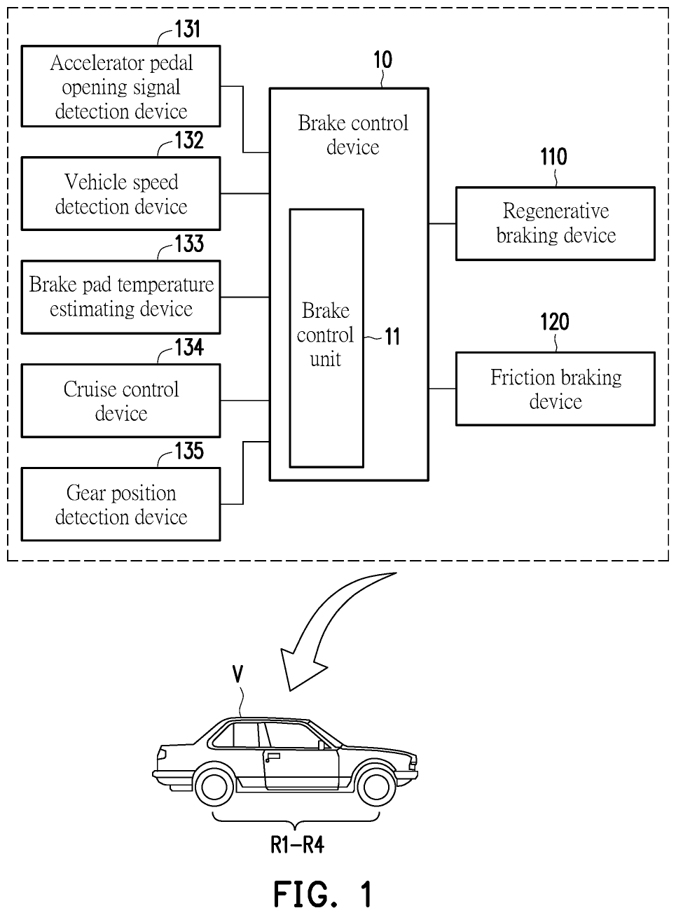

FIG. 1 is a schematic view of a brake control device according to an embodiment of the present disclosure. Firstly, FIG. 1 describes various components and their configuration relationships in the control device, and detailed functions will be disclosed together with the following embodiments.

Please refer to FIG. 1 first, a brake control device 10 is configured in a vehicle V, and at least includes a brake control unit 11. The brake control unit 11 includes a controller that may receive various data received from a detection device to control the actuation of different braking devices. The braking device here includes a regenerative braking device 110 and a friction braking device 120, the regenerative braking device 110 is configured to adjust the regenerative braking force applied to the wheels R1 to R4 of the vehicle V, and the friction braking device 120 is configured to adjust the frictional braking force applied to the wheels of the vehicle V. The detection device may include an accelerator pedal opening signal detection device 131, a vehicle speed detection device 132, a brake pad temperature estimating device 133, a cruise control device 134, a gear position detection device 135, etc., and details thereof will be described in the following embodiments.

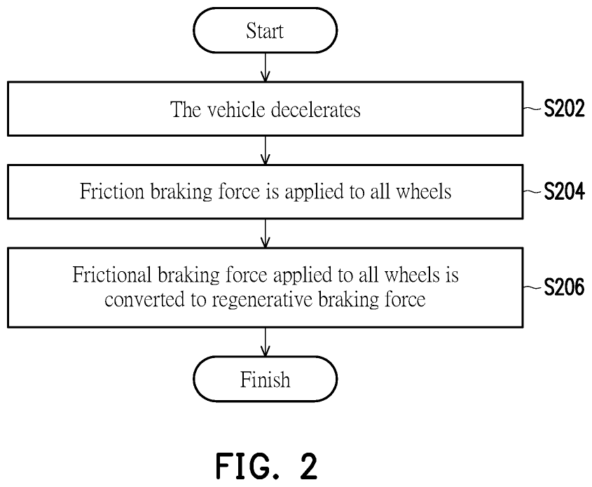

FIG. 2 is a flowchart of a brake control method of a brake control device according to an embodiment of the present disclosure. The method flow in FIG. 2 may be realized by the brake control device 10 in FIG. 1.

Please refer to FIG. 1 and FIG. 2 simultaneously. First, when the vehicle V decelerates (step S202), the brake control unit 11 will perform the braking force application process to apply frictional braking force to all wheels R1 to R4 through the friction braking device 120 (step S204). The frictional braking force here may be, for example, an oil pressure control method to increase the frictional resistance of the wheels R1 to R4, but the present disclosure is not limited thereto.

It should be noted that the brake control unit 11 may use different methods to detect whether the vehicle V has decelerated, so as to determine the timing of performing the braking force application process.

In an embodiment, the brake control unit 11 performs the braking force application process of applying frictional braking force to all the wheels R1 to R4 when the accelerator pedal is turned off (i.e., the accelerator pedal is released but not stepped on). Since the brake control process is performed based on the driver's operation, the process may be performed when the driver has the intention to decelerate. When the accelerator pedal is off, the deceleration signal will not be sent (i.e., the brake lights will not be turned on), so vehicles behind will not receive unnecessary signals.

In an embodiment, the brake control unit 11 performs the braking force application process of applying the frictional braking force to all the wheels R1 to R4 when the accelerator pedal opening signal detection device 131 detects that the accelerator pedal opening decreases at a predetermined rate. That is, by detecting the operation of whether the driver releases the accelerator pedal, the attitude control of the vehicle V may be started earlier.

In an embodiment, the brake control unit 11 performs the braking force application process of applying frictional braking force to all the wheels R1 to R4 when the brake control unit is adopted during the braking operation, that is, the process is carried out when the driver obviously has the intention of slowing down or stopping.

Next, the brake control unit 11 converts the frictional braking force applied to the wheels R1 to R4 into the regenerative braking force, so as to increase the regenerative braking force applied to the wheels R1 to R4 through the regenerative braking device 110 (step S206). In general, when the driver decelerates the vehicle V, the braking force varies depending on the charging state of the secondary battery. However, the brake control device 10 in this embodiment applies frictional braking force to all the wheels R1 to R4 to suppress the pitching effect, and when the attitude of the vehicle V is stabilized, all the wheels R1 to R4 will be gradually applied with regenerative braking force. Therefore, the brake control device 10 in this embodiment does not need to measure the speed and judge the attitude of the vehicle V, thereby simplifying the brake control process.

It should be noted that the brake control unit 11 will not perform the brake control process in a specific situational.

In an embodiment, the brake control unit 11 may determine whether to execute the brake control according to the vehicle speed detection device 132 used to detect the vehicle speed and the brake pad temperature estimating device 133 configured with the brake pedal force detection switch attached to the brake pedal to detect the brake pedal force. The vehicle speed detection device 132 here is, for example, an electronic stability control system (ESC), which may detect the vehicle speed and steering angle to determine whether the vehicle has an unstable state such as oversteering or understeering, and perform automatic control of the output of brake and electric motor in an integrated manner. Specifically, the brake pad temperature estimating device 133 may estimate the brake pad temperature according to the vehicle speed and the brake pedal force. When the brake pad temperature is greater than a set threshold, the brake control unit 11 will not perform the brake control. That is, the brake control unit 11 will determine whether the actuation control process can be performed in consideration of the state of the brake pads to reduce the load on the brake control unit 11 itself.

In an embodiment, the brake control unit 11 may determine whether to perform the brake control according to the cruise control device 134. Specifically, when the cruise control device is activated, and when the vehicle V is decelerated due to the operation of brake pedal, the brake control unit 11 will not perform brake control. Since the accuracy of friction braking varies with temperature and humidity, and when cruise control or autopilot is engaged, deceleration request will vary. Therefore, by accurately executing the deceleration request of the cruise control, it is possible to prevent the attitude change of the vehicle V due to the acceleration and deceleration request.

In an embodiment, the brake control unit 11 may control the magnitude of the frictional braking force according to the gear position detection device 135 for detecting the gear position of the transmission selected by the driver. Specifically, when the gear position detection device detects a shift to a gear with increased deceleration, the same frictional braking force as selected during normal gear shifting will be applied to all wheels R1 to R4, and the insufficient portion will be applied by regenerative braking force. That is, when the deceleration request of the vehicle V is increased, the frictional braking force will increase, and the brake pad temperature will increase as well. Therefore, when gear B is selected, the same frictional braking force as used when gear D is selected will be applied, and the insufficient portion is applied by regenerative braking force, so the braking load may be further reduced.

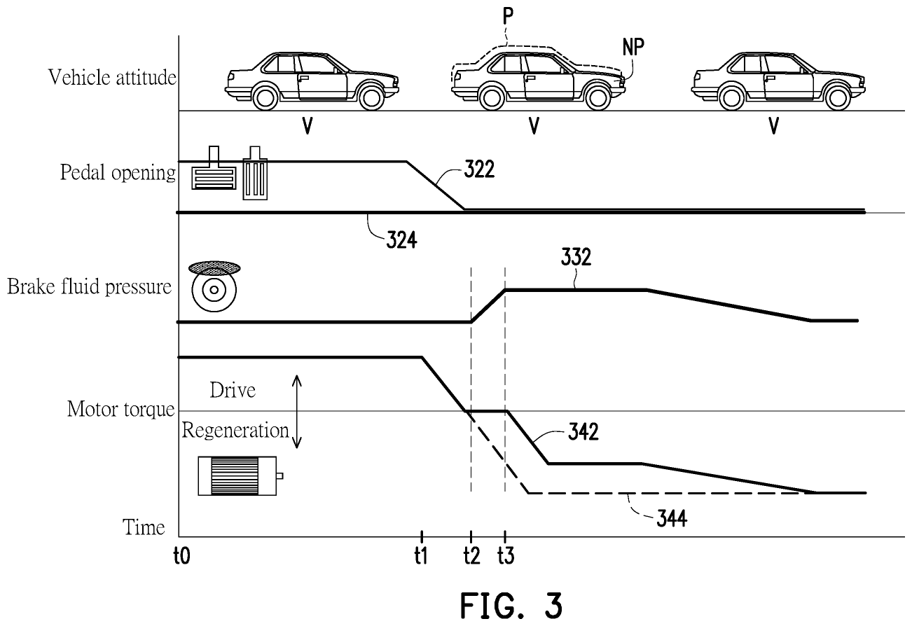

FIG. 3 is a schematic view illustrating a situation of a brake control method of a brake control device according to an embodiment of the present disclosure. The method flow in FIG. 3 may be realized by the brake control device 10 in FIG. 1. In this embodiment, the vehicle V is driven using an electric motor.

Please refer to FIG. 1 and FIG. 3 at the same time. In this embodiment, the accelerator pedal 322 is stepped on at time t0, and the electric motor generates a torque 342 for driving the driving side at time t0. When the vehicle V decelerates at time t1 and time t2 due to the off operation of the accelerator pedal 322, the brake control unit 11 applies the frictional braking force to all the wheels R1 to R4 at time t3. Throughout the process, the brake pedal 324 is not treaded.

Furthermore, in the vehicle V performing regenerative braking, when the accelerator pedal is treaded, the electric motor generates torque to drive the driving side, and when the brake pedal is treaded, the electric motor generates torque to drive the deceleration side.

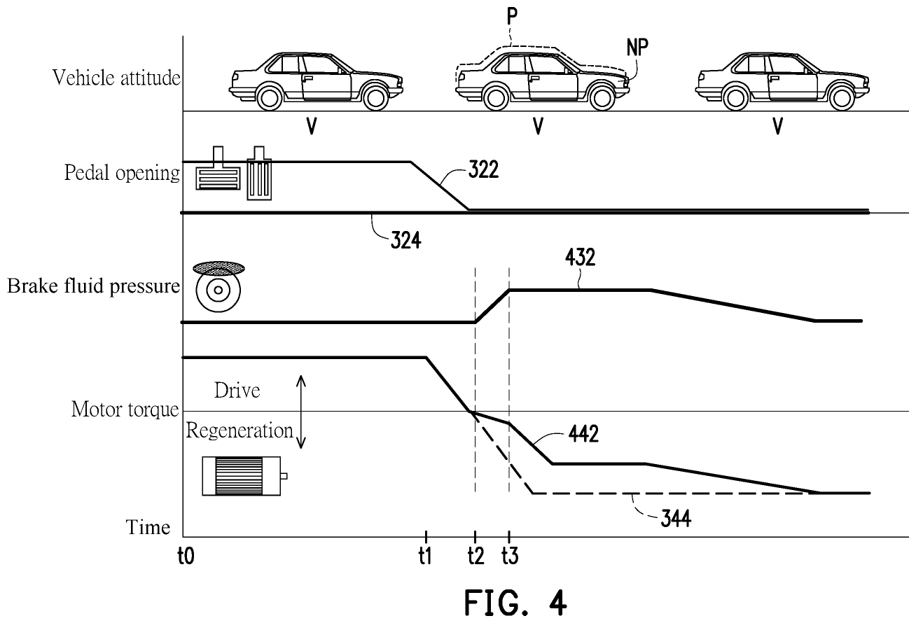

FIG. 4 is a schematic view illustrating a situation of a brake control method of a brake control device according to another embodiment of the present disclosure. The method flow in FIG. 4 may be realized by the brake control device 10 in FIG. 1. In addition, the parts in FIG. 4 the same as those in FIG. 3 are represented by the same symbols.

Please refer to FIG. 1 and FIG. 4 at the same time. In this embodiment, when the vehicle V decelerates due to the off operation of the accelerator pedal 322, the braking force application in which the brake control unit 11 applies frictional braking force to all the wheels R1 to R4 and the regenerative braking force application 442 in which the regenerative braking force is smaller than the frictional braking force will be applied to the electric motor. The brake control unit 11 simultaneously performs the frictional braking force application process and the regenerative braking force application process within a predetermined time. The predetermined time is a time period (between t2 and t3) from the application of the braking force to the stabilization of the attitude of the vehicle V. When the attitude of the vehicle V is stabilized at time t3, the regenerative braking force applied to the electric motor is gradually increased, and the frictional braking force applied to the wheels R1 to R4 driven by the electric motor will be converted into regenerative braking force. That is to say, when it is detected that the accelerator pedal 322 is turned off to cause deceleration of the vehicle V, the brake control unit 11 will control to apply a frictional braking force 432 greater than the regenerative braking force to suppress the impact at the time point when the motor torque is switched from the driving side to the regenerative side. After the vehicle attitude is stabilized by friction braking on all wheels R1 to R4, the regenerative braking force is slowly increased to suppress the impact when switching from friction braking to regenerative braking.

If the brake control method in FIG. 3 or FIG. 4 is not adopted (for example, immediately switch to the regenerative braking force application process 344 as in a general conventional method), the vehicle V will have a pitching effect P. If the brake control method in FIG. 3 or FIG. is adopted, the brake control method may effectively suppress the pitching effect NP by changing the occurrence time of the above two impacts, so as to reduce the discomfort caused to the passengers during the deceleration process.

To sum up, with the brake control device provided by the present disclosure, when the vehicle is decelerating, all wheels will be applied with friction braking to suppress the pitching effect. After the attitude of the vehicle is stabilized, all wheels will be applied with regenerative braking gradually. The brake control device in this embodiment does not need to perform speed measurement and attitude confirmation for the vehicle, thereby simplifying the brake control process.

Finally, it should be noted that: the above embodiments are only used to illustrate the technical solutions of the present disclosure, but not to limit them; although the present disclosure has been described in detail with reference to the foregoing embodiments, those of ordinary skill in the art should understand: modifications may still be made to the technical solutions described in the foregoing embodiments, or some or all of the technical features thereof are equivalently replaced; and these modifications or replacements do not make the essence of the corresponding technical solutions depart from the scope of the technical solutions of the embodiments of the present disclosure.

What is claimed is:

1. A brake control device for performing brake control of a vehicle, wherein the vehicle has a regenerative braking device and a friction braking device, the regenerative braking device is configured to adjust a regenerative braking force applied to a plurality of wheels of the vehicle, and the friction braking device is configured to adjust a frictional braking force applied to the wheels, and the brake control device comprising:
a brake control unit, configured to control the regenerative braking device and the friction braking device,
wherein when the vehicle is decelerated, after the brake control unit performs a braking force application process to apply the frictional braking force to all of the wheels, the brake control unit increases the regenerative braking force applied to the wheels by converting the frictional braking force applied to the wheels into the regenerative braking force.

2. The brake control device according to claim 1, wherein the brake control unit is adopted when an accelerator pedal is turned off, and the brake control unit performs the braking force application process to apply the frictional braking force to all of the wheels.

3. The brake control device according to claim 1, wherein the vehicle has an accelerator pedal opening signal detection device, when the accelerator pedal opening signal detection device detects that an accelerator pedal opening decreases at a predetermined rate, the brake control unit performs the braking force application process to apply the frictional braking force to all of the wheels.

4. The brake control device according to claim 1, wherein the brake control unit is adopted when performing a braking operation, and the brake control unit performs the braking force application process to apply the frictional braking force to all of the wheels.

5. The brake control device according to claim 1, wherein
the vehicle has a vehicle speed detection device for detecting a vehicle speed,
a brake pedal force detection switch attached to a brake pedal for detecting a brake pedal force is equipped with a brake pad temperature estimating device, wherein the brake pad temperature estimating device estimates a brake pad temperature according to the vehicle speed and the brake pedal force,
when the brake pad temperature is greater than a set threshold, the brake control unit does not perform the brake control.

6. The brake control device according to claim 2, wherein
the vehicle has a vehicle speed detection device for detecting a vehicle speed,
a brake pedal force detection switch attached to a brake pedal for detecting a brake pedal force is equipped with a brake pad temperature estimating device, wherein the brake pad temperature estimating device estimates a brake pad temperature according to the vehicle speed and the brake pedal force,
when the brake pad temperature is greater than a set threshold, the brake control unit does not perform the brake control.

7. The brake control device according to claim 3, wherein
the vehicle has a vehicle speed detection device for detecting a vehicle speed,
a brake pedal force detection switch attached to a brake pedal for detecting a brake pedal force is equipped with a brake pad temperature estimating device, wherein the brake pad temperature estimating device estimates a brake pad temperature according to the vehicle speed and the brake pedal force,
when the brake pad temperature is greater than a set threshold, the brake control unit does not perform the brake control.

8. The brake control device according to claim 4, wherein
the vehicle has a vehicle speed detection device for detecting a vehicle speed,
a brake pedal force detection switch attached to a brake pedal for detecting a brake pedal force is equipped with a brake pad temperature estimating device, wherein the brake pad temperature estimating device estimates a brake pad temperature according to the vehicle speed and the brake pedal force,
when the brake pad temperature is greater than a set threshold, the brake control unit does not perform the brake control.

9. The brake control device according to claim 1, wherein
the vehicle has a cruise control device,
when the cruise control is activated, and when the vehicle is decelerating due to an operation of a brake pedal, the brake control unit does not perform the brake control.

10. The brake control device according to claim 1, wherein
the vehicle has a gear position detection device to detect a gear position of a transmission selected by a driver,
when the gear position detection device detects a shift to a gear with increased deceleration, the identical frictional braking force as selected during normal gear shifting is applied to all of the wheels, and an insufficient portion is applied by the regenerative braking force.

11. The brake control device according to claim 2, wherein
the vehicle has a gear position detection device to detect a gear position of a transmission selected by a driver,
when the gear position detection device detects a shift to a gear with increased deceleration, the identical frictional braking force as selected during normal gear shifting is applied to all of the wheels, and an insufficient portion is applied by the regenerative braking force.

12. The brake control device according to claim 3, wherein
the vehicle has a gear position detection device to detect a gear position of a transmission selected by a driver,
when the gear position detection device detects a shift to a gear with increased deceleration, the identical frictional braking force as selected during normal gear shifting is applied to all of the wheels, and an insufficient portion is applied by the regenerative braking force.

13. The brake control device according to claim 4, wherein
the vehicle has a gear position detection device to detect a gear position of a transmission selected by a driver,
when the gear position detection device detects a shift to a gear with increased deceleration, the identical frictional braking force as selected during normal gear shifting is applied to all of the wheels, and an insufficient portion is applied by the regenerative braking force.

14. The brake control device according to claim 1, wherein
the vehicle is driven using an electric motor,
in the vehicle performing regenerative braking, the electric motor generates a torque to drive a driving side when an accelerator pedal is treaded, and the electric motor generates a torque to drive a deceleration side when a brake pedal is treaded,
when the vehicle is decelerated due to an off operation of the accelerator pedal, the braking force application in which the brake control unit applies the frictional braking force to all of the wheels and a regenerative braking force application in which the regenerative braking force is smaller than the frictional braking force are applied to the electric motor, the brake control unit simultaneously performs the braking force application process and the regenerative braking force application process within a predetermined time,
the predetermined time is a time period from an application of a braking force to stabilization of an attitude of the vehicle,
when the attitude of the vehicle is stabilized, the regenerative braking force applied to the electric motor is gradually increased, and the frictional braking force applied to the wheels driven by the electric motor is converted into the regenerative braking force.
